(19) United States
(12) Patent Application Publication
(10) Pub. No.: US 2021/0058670 A1
(43) Pub. Date: Feb. 25, 2021

(54) METHOD FOR BROADCAST OF MULTIMEDIA CONTENT MEASURING THE ATTENTION OF A USER

(71) Applicant: SAGEMCOM BROADBAND SAS, Rueil Malmaison (FR)

(72) Inventor: Farid BENAMROUCHE, Rueil Malmaison (FR)

(21) Appl. No.: 16/070,657

(22) PCT Filed: Jan. 12, 2017
(86) PCT No.: PCT/EP2017/050521

§ 371 Date: Jul. 17, 2018

(30) Foreign Application Priority Data
Jan. 18, 2016 (FR) 1650379

(51) Int. Cl. H04N 21/442; H04N 21/422; H04N 21/433; H04N 21/845; G06F 16/44; G06F 16/435

(52) U.S. Cl. CPC H04N 21/44218; H04N 21/42201; G06F 16/436; H04N 21/8456; G06F 16/44; H04N 21/4334

(57) ABSTRACT

A method of broadcasting a multimedia content implemented by a broadcasting system including a decoder, a display, a sensor of biometric data and a database; the method including acquiring first biometric data of a user; recording, by the decoder, the first biometric data; associating by the decoder the first biometric data with a user attention level; first comparing, by the decoder, the user attention level with the first biometric data with the user attention level associated with previously recorded second biometric data; when the level of attention of the user increases, second comparing, by the decoder, the variation of the level of attention of the user with the expected variation, extracted from the database, of the level of attention of the user for the period of the multimedia content during broadcasting; when the measured variation and the expected variation are substantially identical, broadcasting a message by the decoder.

### TECHNICAL FIELD OF THE INVENTION

The technical field of the invention is that of broadcast of multimedia content. The present invention relates to a method of broadcast of multimedia content, and in particular a method of broadcast of multimedia content measuring the attention of a user.

### TECHNOLOGICAL BACKGROUND OF THE INVENTION

When multimedia content is broadcast it is important during certain periods to ensure that the user is paying attention. This is the case, for example, when the broadcast content relates to important content, such as an advertisement or a message of the “abduction alert” type.

To ensure that the user is paying attention it is known to use easily identifiable acoustic signals, such as a jingle, or alternatively a piece of music. However, this technique does not guarantee that the user will pay maximum attention. Indeed, the solution is completely passive, in the sense that it does not enable it to be determined whether the acoustic signal has indeed been effective, and if the user's attention has indeed been captured.

There is therefore a need for a method of broadcast guaranteeing that a user is paying sufficient attention before an important content is broadcast.

### SUMMARY OF THE INVENTION

The invention provides a solution to the above-mentioned problems, by enabling a user's attention to be monitored through the use of biometric data, and by broadcasting an important item only when the user is paying sufficient attention.

To accomplish this, a first aspect of the invention relates to a method of broadcast of multimedia content implementing a broadcasting system, and measuring the attention of a user.

The broadcasting system includes a decoder, a means of display, a sensor for the biometric data of a user located in proximity to the means of display, and a database; where the means of display, the database and the biometric data sensor are connected to the decoder; where the multimedia content is displayed by the means of display, and divided into different periods; where the database includes, for each of the said periods, an expected variation of the user's level of attention.

The term “decoder” is understood to mean a device containing means of decoding and encoding an audio or video signal, means of connecting to a network, means of transmitting audio and video signals to a means of display, and computation means associated with recording means.

The term “means of display” is understood to mean all means of broadcast of multimedia content. This therefore relates to a means of display also including audio broadcast means, for example a television or a smartphone.

The method according to the invention includes:
a step of acquisition of first biometric data relating to a user, using the biometric data sensor;
a step of recording, by the decoder, of the first biometric data;
a step of association by the decoder of the first biometric data with a level of attention of the user;
a first step of comparison, by the decoder, of the user's level of attention associated with the first biometric data with the user's level of attention associated with previously recorded second biometric data;
if the user's level of attention increases, a second step of comparison, by the decoder, of the measured variation of the user's level of attention with the expected variation of the user's level of attention taken from the database by the decoder for the period of the multimedia content currently being broadcast;
if the measured variation and the expected variation are appreciably identical, a step of implementation of an action by the decoder.

The action implemented by the decoder is thus performed only when the user's level of attention increases. In addition, the said action is performed only if the measured change of the user's attention matches the expected change of the user's attention, given the nature of the broadcast content. In other words, the action is performed only when the user's attention is directed towards the means of display, and not directed to an activity unrelated with the broadcast content. The action can, for example, be the broadcast of an important item of information for the user's attention, such as an advertising message or a message of the “abduction alert” type. This important information is then broadcast when the user's attention is directed towards the means of display.

In addition to the characteristics which have just been mentioned in the previous paragraph, according to one aspect of the invention the method of broadcast may have one or more additional characteristics, from among the following, considered individually or in all technically possible combinations.

Advantageously, the method of broadcast includes, immediately after the step of acquisition of the first biometric data, a third step of comparison by the decoder of the first biometric data with the second biometric data, where the method performs a new step of acquisition if the first biometric data and the second biometric data are appreciably identical.

The method according to the invention is thus performed in its entirety only if a change of biometric data is observed. The second biometric data will therefore be reused in a subsequent iteration of the method according to the invention if no change of the biometric data is observed.

Advantageously, the method of broadcast includes, immediately after the first step of comparison, and if the level of attention is reduced, a step of transmission, on an instruction of the decoder, of a signal in order to attract the user's attention.

Advantageously, the method of broadcast includes, immediately after the second step of comparison, and if the measured variation and the expected variation are not identical, a step of transmission, on an instruction of the decoder, of a signal in order to attract the user's attention.

The user's attention is thus stimulated when the said user seems no longer to be paying attention to the broadcast content.

The database preferably includes, for each period, a data element relating to the action to be implemented by the decoder in the step of implementation of an action, i.e. when the measured variation of the level of attention and the expected variation of the level of attention are appreciably identical. The action to be implemented can thus be adapted to the broadcast content.

Advantageously, the biometric data sensor consists of an intelligent bracelet or an intelligent pair of glasses. It is thus not necessary to install biometric sensors on the means of display or on the decoder.

Advantageously, the biometric data includes data relative to the user's heart rate and/or level of perspiration and/or temperature and/or brain activity and/or respiratory rate.

A second aspect of the invention concerns a decoder for broadcast of multimedia content, where the said decoder includes means to be connected to:
a means of display intended to display the multimedia content, where the said multimedia content is divided into different periods;
a biometric data sensor configured to acquire first biometric data relating to a user in proximity to the means of display;
a database including, for each of the said periods, an expected variation of the user's level of attention.

According to a second aspect of the invention the decoder also includes means to:
record the first biometric data derived from the biometric data sensor;
associate the first biometric data with a level of attention of the user;
compare the user's level of attention associated with the first biometric data with the user's level of attention associated with previously recorded second biometric data;
if the user's level of attention increases, compare the measured variation of the user's level of attention with the expected variation of the user's level of attention taken from the database for the period of the multimedia content currently being broadcast;
if the measured variation and the expected variation are appreciably identical, implement an action consisting of an operation to broadcast a message.

A third aspect of the invention concerns a computer program product including instructions which lead the decoder, according to a second aspect of the invention, to execute the steps of the method according to a first aspect of the invention.

A fourth aspect of the invention relates to a computer-readable medium on which the computer program product according to a third aspect of the invention is recorded.

The invention and its various applications will be better understood on reading the description which follows, and on examining the figures which accompany it.

### BRIEF DESCRIPTION OF THE FIGURES

Other characteristics and advantages of the invention will be seen clearly on reading the detailed description below, with reference to the appended figures, which illustrate:

FIG. 1, a diagrammatic representation of the broadcast system according to the invention;

FIG. 2, a flowchart of the method of the invention according to a first implementation;

FIG. 3, a flowchart of the method of the invention according to a second implementation;

FIG. 4, a flowchart of the method of the invention according to a third implementation;

FIG. 5, a flowchart of the method of the invention according to a fourth implementation;

### DETAILED DESCRIPTION

Unless otherwise stipulated, a given element shown in different figures has a single reference.

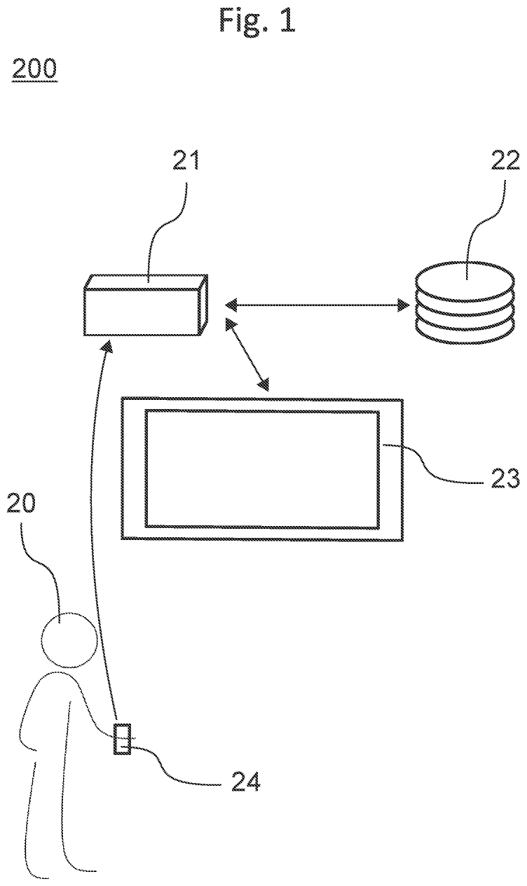

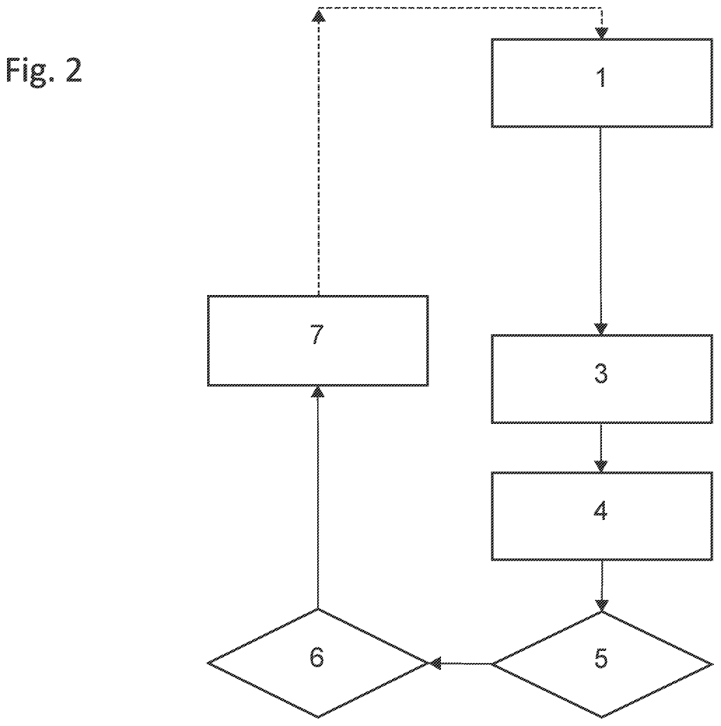

In one implementation illustrated in FIGS. 1 and 2, the method of broadcast of multimedia content measuring the attention of a user is implemented by a broadcast system 200 including a decoder 21, a means of display 23, a biometric data sensor 24 of a user 20 in proximity to means of display 23 and a database 22.

As previously explained, the term “decoder” 21 is understood to mean a device containing means of decoding and encoding an audio or video signal, means of connecting to a network, means of transmitting audio and video signals to a means of display, and computation means associated with recording means.

Similarly, the term “means of display” 23 is understood here to mean all means of broadcast of multimedia content. Means of display 23 can therefore take the form of a television, preferably a flat-screen television. In an alternative or complementary manner, means of display 23 can take the form of a smartphone.

Biometric data sensor 24 can take the form of an intelligent bracelet or an intelligent watch, where the said bracelet or the said watch includes one or more biometric sensors. In an alternative or complementary manner, biometric data sensors 24 can be integrated in means of display 23 or decoder 21.

Means of display 23, database 22 and biometric data sensor 24 are connected to decoder 21. This connection can, for example, take the form of a connection of the Wifi or Bluetooth type. In an alternative or complementary manner, this connection can be made through a LAN (Local Area Network) or through an Internet connection.

The multimedia content broadcast by display means 23 is divided into periods defined by a start time and an end time. The content can, for example, relate to a film or a television programme. In this case the periods correspond to different scenes of the film or to different moments in the programme. Database 22 includes, for each of the said periods, an expected variation of the level of attention of user 20. For example, if the multimedia content concerns a film, a first period can correspond to a contemplative scene, and be followed by a second period corresponding to an action scene. In this case database 22 can include information indicating that an increase of the level of attention of user 20 corresponds to the second period, involving an action scene.

The database can be integrated in the decoder. In this case the content of the database can be downloaded. Alternatively, the database data can be obtained through the EPG (Electronic Program Guide), or through DVB (Digital Video Broadcasting) EITs (Event Information Tables).

The method according to the invention includes:
a step of acquisition 1 of first biometric data relating to a user 20, using biometric data sensor 24;
a step of recording 3, by decoder 21, of the first acquired biometric data;
a step of association 4, by decoder 21, of the first biometric data with a level of attention of user 20;
a first step of comparison 5, by decoder 21, of the level of attention of user 20 associated with the first biometric data with the level of attention of user 20 associated with previously recorded second biometric data.

The association of the biometric data with a level of attention of user 20 depends on the measured biometric data. For example, if the measured biometric data is the heart rate the heart rate can be associated with a level of attention of user 20 using a strictly increasing function. An increase of the heart rate will thus be associated with an increase of the level of attention of user 20. For example, the function of association of the heart rate of user 20 with a level of attention of said user 20 can take the form of an affine function of the following type:

A=a×f

where A is the level of attention of user 20, a a positive constant and f the heart rate. Since the method is concerned only with the variation of the level of attention, the value of constant a can be chosen freely.

The second previously recorded biometric data can come be taken a previous iteration, by broadcast system 200, of the method according to the invention. In an alternative or complementary manner, the second previously recorded biometric data can come from a step of initialization, during which reference values are defined, possibly during a learning phase performed by the decoder.

The method according to the invention also includes:
if the level of attention increases, a second step of comparison 6, by decoder 21, of the measured variation of the level of attention of user 20 with the expected variation of the level of attention of user 20 taken from database 22 by the decoder for the period of the multimedia content currently being viewed;
if the measured variation and the expected variation are appreciably identical, a step of implementation of an action 7 by the decoder.

The term “appreciably identical” is understood to mean a difference between the measured variation and the expected variation which is less than or equal to 20%, or less than or equal to 5%. If applicable, this threshold can be modified in accordance with the nature of the measured biometric data, or with the measurement accuracy of this biometric data.

The action implemented by decoder 21 is thus performed only when the level of attention of user 20 increases. In addition, the said action is performed only if the measured change of the attention of user 20 matches the expected change of the attention of user 20, given the nature of the broadcast content. The action is thus performed only when the attention of user 20 is directed towards means of display 23, and not to an activity unrelated with the broadcast content.

The method according to the invention can be repeated at regular intervals to monitor the attention of user 20. A wait period between each iteration can be defined. This wait period can be constant, depend on the acquired biometric data, or depend on the broadcast content.

In one implementation, the action implemented by decoder 21 consists in displaying, by means of display 23, information which is important to user 20. The information is thus displayed when the attention of user 20 directed towards means of display 23 is high, and has a higher chance of being absorbed by user 20. The information can, for example, be an advertising message or a message of the “abduction alert” type. The important information is thus broadcast when the user's attention is directed towards the means of display.

In one implementation the first biometric data is acquired in a sliding window. The duration of this sliding window varies according to the acquired biometric data. For example, if the biometric data relates to the heart rate the duration of the sliding window may be roughly equal to ten seconds. In another example, if the biometric data relates to the perspiration rate the duration of the sliding window may be roughly equal to one minute.

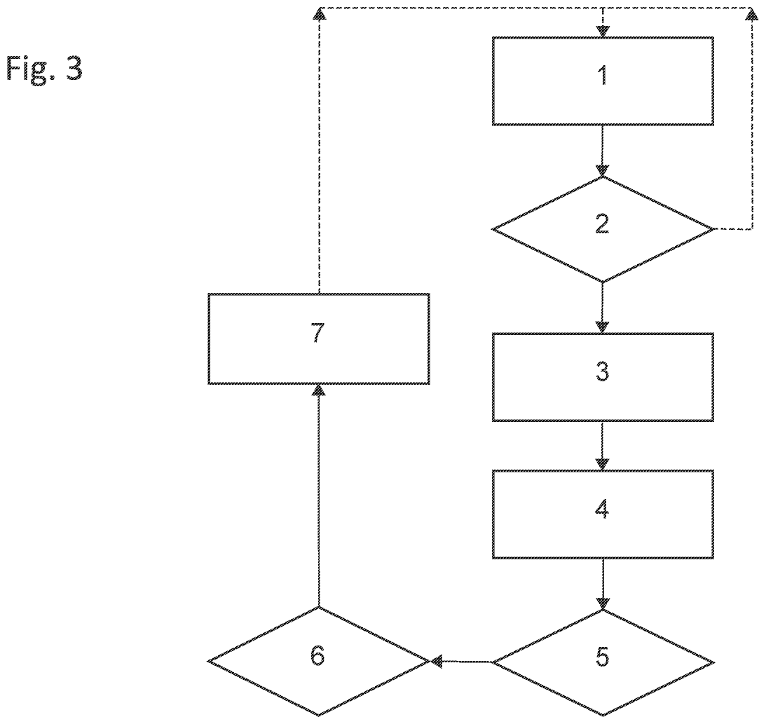

In one implementation illustrated in FIG. 3, the method includes, immediately after step of acquisition 1 of biometric data, a third step of comparison 2 by decoder 21 of the first biometric data acquired with the previously recorded second biometric data, where the method performs a new step of acquisition 1 if the acquired and recorded biometric data are appreciably identical. A time delay can be applied such that the new iteration of the method is not performed immediately, but only after a given time period.

The biometric data is considered to be appreciably identical if the first biometric data is not more than 20% greater or less than the second biometric data. Alternatively, the biometric data is considered to be appreciably identical if the first biometric data is not more than 5% greater or less than the second biometric data.

This implementation means that the entire method is not performed if no change of the biometric data is observed. The second biometric data is therefore reused in the next iteration of the method according to the invention by broadcast system 200.

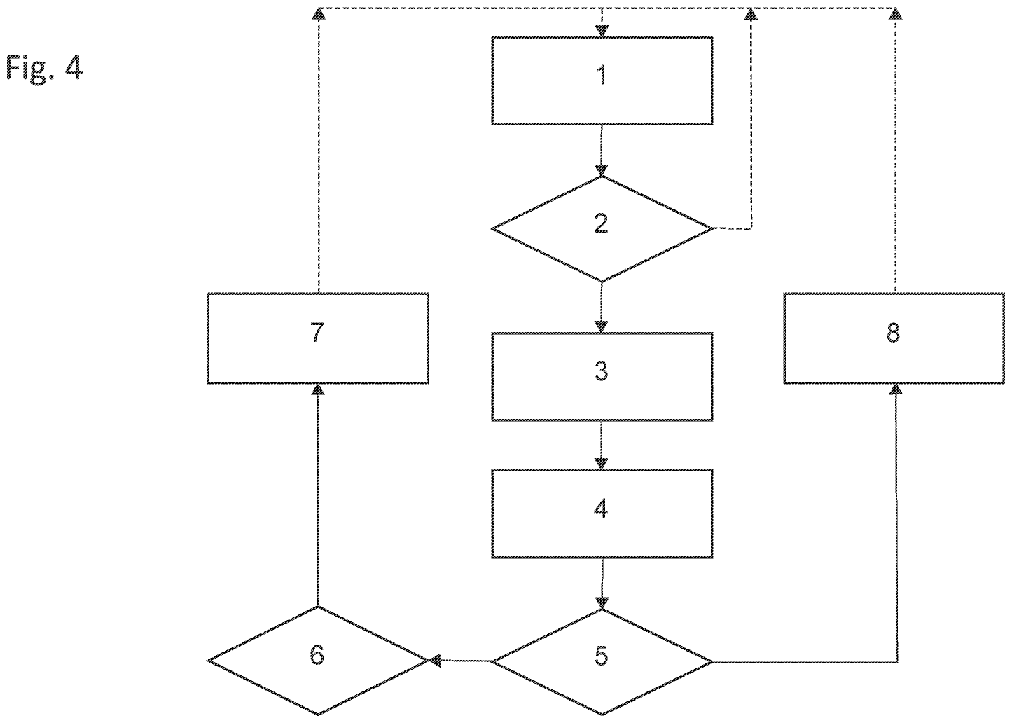

In one implementation illustrated in FIG. 4, the method of broadcast according to the invention includes, immediately after first step of comparison 5, and if the level of attention is reduced, a step of transmission 8, on an instruction of decoder 21, of a signal in order to attract the attention of user 20. The signal can, for example, be transmitted by display means 23. The signal can consist of a piece of music, an optical signal or alternatively a short sound. Transmission of the signal may possibly be accompanied by a step of proposal, by means of display means 23, of a fun activity to user 20. In an alternative or complementary manner, decoder 21 includes means of transmission of an audio and/or visual signal and the signal is transmitted by decoder 21.

This step enables the attention of user 20 to be attracted when the latter seems no longer to be paying attention to the broadcast content.

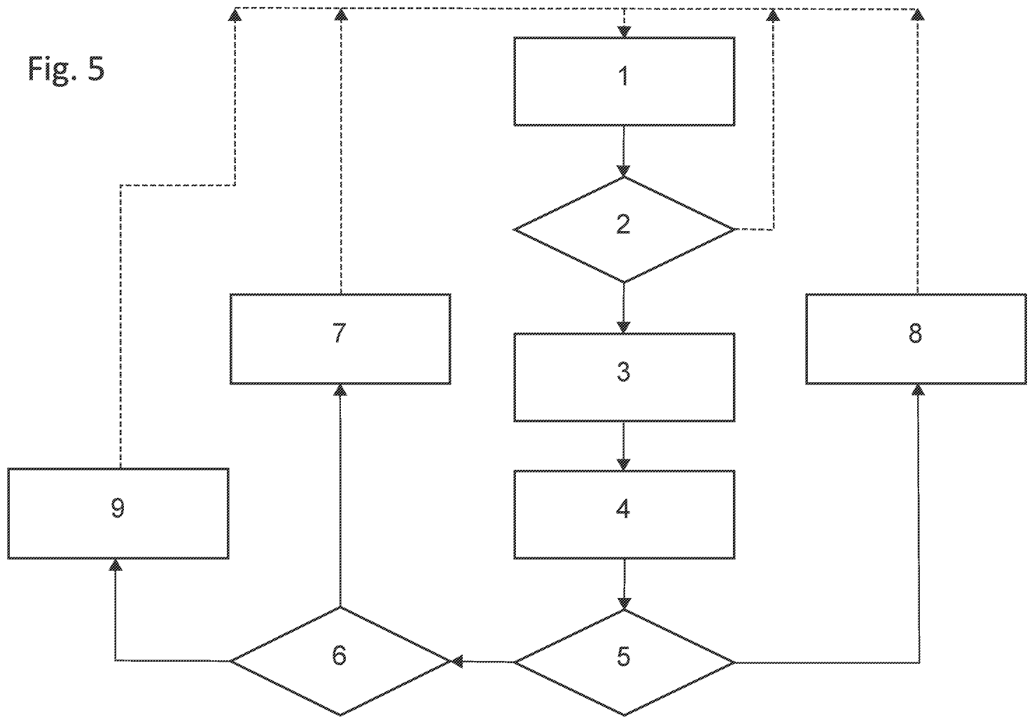

In one implementation illustrated in FIG. 5, the method of broadcast according to the invention includes, immediately after second step of comparison 6, and if the measured variation and the expected variation are not identical, a step of transmission 9, on an instruction of decoder 21, of a signal in order to attract the attention of user 20. The signal can for example be transmitted by display means 23.

This step enables system 200 to detect when a change of the attention of user 20 is caused by an element unrelated to the broadcast content, and once again to draw their attention towards the broadcast content by transmitting a signal. The signal can consist of a piece of music, an optical signal or alternatively a short sound. Transmission of the signal may possibly be accompanied by a step of proposal, by means of display means 23, of a fun activity to user 20. In an alternative or complementary manner, decoder 21 includes means of transmission of an audio and/or visual signal and the signal is transmitted by decoder 21.

In one implementation of the method according to the invention, database 22 also includes, for each period, a data element relating to the action to be implemented by decoder 21 in step of implementation of an action 7, i.e. when the measured variation of the level of attention and the expected variation of the level of attention are identical.

The action to be performed can thus be adapted to the broadcast content. If, for example, the subject of the broadcast content relates to vehicles, the action to be performed may consist of an instruction sent to display means 23 by decoder 21 generating a message containing information relating to one vehicle in particular.

In one implementation of the method of broadcast according to the invention, biometric data sensor 24 consists of an intelligent bracelet or an intelligent pair of glasses. In this configuration it is not necessary to incorporate biometric sensors in means of display 23 or decoder 21.

In one implementation of the method of broadcast according to the invention, the biometric data includes data relative to the heart rate and/or level of perspiration and/or temperature and/or brain activity and/or respiratory rate of user 20.

1. A method of broadcast of multimedia content, the method implementing a broadcast system including a decoder, a display system, a biometric data sensor of a user in proximity to the display system and a database; wherein the display system, the database and the biometric data sensor are connected to the decoder; wherein the multimedia content is displayed by the display system, and divided into different periods; wherein the database includes, for each of the periods, an expected variation of the level of attention of the user; wherein the method includes:
a step of acquisition of first biometric data relating to the user, using the biometric data sensor;
a step of recording, by the decoder, of the first biometric data;
a step of association, by the decoder, of the first biometric data with a level of attention of the user;
a first step of comparison, by the decoder, of the level of attention of the user associated with the first biometric data with the level of attention of the user associated with previously recorded second biometric data;
when the level of attention of the user increases, a second step of comparison, by the decoder, of the measured variation of the level of attention of the user with the expected variation of the level of attention of the user taken from the database by the decoder for the period of the multimedia content currently being broadcast;
when the measured variation and the expected variation are appreciably identical, a step of implementation of an action consisting of an operation to broadcast a message by the decoder.

2. The method of broadcast according to claim 1, comprising, immediately after the step of acquisition of the first biometric data, a third step of comparison by the decoder of the first biometric data with the second biometric data, wherein the method performs a new step of acquisition when the first biometric data and the second biometric data are appreciably identical.

3. The method of broadcast according to claim 1, comprising, immediately after the first step of comparison, and when the level of attention is reduced, a step of transmission, on an instruction of the decoder, of a signal.

4. The method of broadcast according to claim 1, comprising, immediately after the second step of comparison, and when the measured variation and the expected variation are not identical, a step of transmission, on an instruction of the decoder, of a signal.

5. The method of broadcast according to claim 1, wherein the database includes, for each period, a data element relating to the message to be broadcast in the course of the operation to broadcast a message by the decoder in the step of implementation of an action.

6. The method of broadcast according to claim 1, wherein the biometric data sensor consists of a bracelet including a biometric sensor, or a pair of glasses including a biometric sensor.

7. The method of broadcast according to claim 1, wherein the biometric data includes data relative to the heart rate and/or level of perspiration and/or temperature and/or brain activity and/or respiratory rate of the user.

8. A decoder for broadcast of multimedia content, the decoder comprising means to be connected to:
a means of display intended to display the multimedia content, wherein the multimedia content is divided into different periods;
a biometric data sensor configured to acquire first biometric data relating to a user in proximity to the means of display;
wherein a database includes, for each of the said periods, an expected variation of the level of attention of the user;
wherein the decoder includes means to:
record the first biometric data derived from the biometric data sensor;
associate the first biometric data with a level of attention of the user;
compare the level of attention of the user associated with the first biometric data with the level of attention of the user associated with previously recorded second biometric data;
when the level of attention of the user increases, compare the measured variation of the level of attention of the user with the expected variation of the level of attention of the user taken from the database for the period of the multimedia content currently being broadcast;
when the measured variation and the expected variation are appreciably identical, implement an action consisting of an operation to broadcast a message.

9. (canceled)

10. A non-transitory computer-readable medium, comprising instructions for performing the steps of the method of claim 1.
